(19) United States
(12) Patent Application Publication
(10) Pub. No.: US 2025/0060744 A1
(43) Pub. Date: Feb. 20, 2025

(54) ANOMALY PREDICTION APPARATUS, ANOMALY PREDICTION SYSTEM, ANOMALY PREDICTION METHOD, AND COMPUTER READABLE MEDIUM

(71) Applicant: Mitsubishi Electric Corporation, Tokyo (JP)

(72) Inventor: Koji SHIBATA, Tokyo (JP)

(73) Assignee: Mitsubishi Electric Corporation, Tokyo (JP)

(21) Appl. No.: 18/935,118

(22) Filed: Nov. 1, 2024

Related U.S. Application Data
(63) Continuation of application No. PCT/JP2022/024849, filed on Jun. 22, 2022.

(51) Int. Cl. G05B 23/02

(52) U.S. Cl. CPC G05B 23/0283; G05B 23/0243

(57) ABSTRACT

An anomaly prediction apparatus (100) includes a deterioration prediction unit (120). Regarding a target part that a target device includes as deteriorated at a subject point in time and the target part at the subject point in time as a target deteriorated part, a deterioration prediction unit (120) predicts a point in time an anomaly will occur in the target device, in a case where there is a dissimilarity between a relative position of a driving portion corresponding to the target deteriorated part with respect to a different part and a relative position of a driving portion corresponding to the target part of a case where the target part is not deteriorated with respect to the different part, and the anomaly is estimated to occur in the target device by the target deteriorated part becoming more deteriorated and a distance between the driving portion corresponding to the target part and the different part reaching an anomalous distance, based on a residual distance that is a difference between the distance between the driving portion corresponding to the target deteriorated part and the different part, and the anomalous distance.

### CROSS REFERENCE TO RELATED APPLICATIONS

This application is a Continuation of PCT International Application No. PCT/JP2022/024849 filed on Jun. 22, 2022, all of which is hereby expressly incorporated by reference into the present application.

### TECHNICAL FIELD

The present disclosure relates to an anomaly prediction apparatus, an anomaly prediction system, an anomaly prediction method, and an anomaly prediction program.

### BACKGROUND ART

Conventionally, an inspection related to wear of a manufacturing device has been performed by a maintenance worker based on a shape of a part. Although a failure condition can be accurately grasped using the shape of the part, there has been difficulty in accurately predicting a failure timing using the shape of the part.

Patent Literature 1 discloses technology that can estimate a deterioration state of a part while reducing amount of data collected beforehand by generating a model to estimate the deterioration state of the part based on actual operation data in a normal state obtained from a sensor that the part that the manufacturing device includes includes.

### CITATION LIST

### Patent Literature

Patent Literature 1: JP 2022-021202 A

### SUMMARY OF INVENTION

### Technical Problem

According to Patent Literature 1, there is an issue in which since a deterioration state of a single part is a target, an anomaly in a device cannot be predicted based on a position that changes with deterioration of a target part and that is a relative position of a driving portion corresponding to the target part with respect to a different part.

An aim of the present disclosure is to predict an anomaly in a device based on a position that changes with deterioration of a target part and that is a relative position of a driving portion corresponding to the target part with respect to a different part.

### Solution to Problem

An anomaly prediction apparatus according to the present disclosure includes:
a deterioration prediction unit, regarding a target part that a target device includes as deteriorated at a subject point in time and the target part at the subject point in time as a target deteriorated part,
   to predict a point in time an anomaly will occur in the target device, in a case where there is a dissimilarity between a relative position of a driving portion corresponding to the target deteriorated part with respect to a different part and a relative position of a driving portion corresponding to the target part of a case where the target part is not deteriorated with respect to the different part, and the anomaly is estimated to occur in the target device by the target deteriorated part becoming more deteriorated and a distance between the driving portion corresponding to the target part and the different part reaching an anomalous distance, based on a residual distance that is a difference between the distance between the driving portion corresponding to the target deteriorated part and the different part, and the anomalous distance.

### Advantageous Effects of Invention

According to the present disclosure, in a case where an anomaly is estimated to occur in a target device by a target deteriorated part becoming more deteriorated and a distance between a driving portion corresponding to a target part and a different part reaching an anomalous distance, a deterioration prediction unit predicts a point in time when the anomaly is to occur in the target device based on a residual distance that is a difference between a distance between a driving portion corresponding to the target deteriorated part and the different part, and an anomalous distance. Here, a position of the driving portion corresponding to the target part is a position that changes with deterioration of the target part. Thus, according to the present disclosure, an anomaly of a device can be predicted based on the position that changes with the deterioration of the target part and that is a relative position of the driving portion corresponding to the target part with respect to the different part.

### BRIEF DESCRIPTION OF DRAWINGS

FIG. 1 is a diagram illustrating an example of a configuration of an anomaly prediction system 90 according to Embodiment 1.

FIG. 2 is a diagram describing a process of an anomalous location prediction unit 110 according to Embodiment 1.

FIG. 3 is a diagram describing a process of a deterioration prediction unit 120 according to Embodiment 1.

FIG. 4 is a diagram illustrating an example of a hardware configuration of an anomaly prediction apparatus 100 according to Embodiment 1.

FIG. 5 is a flowchart illustrating operation of the anomalous location prediction unit 110 according to Embodiment 1.

FIG. 6 is a flowchart illustrating operation of the deterioration prediction unit 120 according to Embodiment 1.

FIG. 7 is a diagram illustrating an example of a hardware configuration of an anomaly prediction apparatus 100 according to a variation of Embodiment 1.

FIG. 8 is a diagram illustrating an example of a configuration of an anomaly prediction system 90 according to Embodiment 2.

FIG. 9 is a diagram describing a process of a part deterioration prediction unit 130 according to Embodiment 2.

FIG. 10 is a flowchart illustrating operation of the part deterioration prediction unit 130 according to Embodiment 2.

### DESCRIPTION OF EMBODIMENTS

In a description of the embodiments and in drawings, same reference signs are added to same elements and corresponding elements. A description of elements having the same reference signs added will be suitably omitted or simplified. Arrows in diagrams mainly indicate flows of data or flows of processes. “Unit” may be suitably replaced with “circuit”, “step”, “procedure”, “process”, or “circuitry”.

### Embodiment 1

The present embodiment will be described in detail below by referring to the drawings.

### ***Description of Configuration***

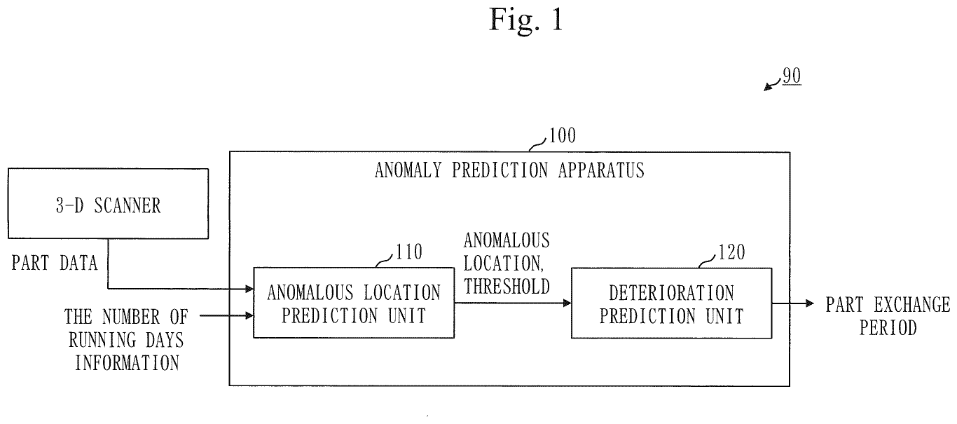

FIG. 1 illustrates an example of a configuration of an anomaly prediction system 90 according to the present embodiment. The anomaly prediction system 90 includes an anomaly prediction apparatus 100 and a 3-D (three-dimensional) scanner as illustrated in FIG. 1.

The anomaly prediction apparatus 100 includes an anomalous location prediction unit 110 and a deterioration prediction unit 120 as illustrated in FIG. 1.

The 3-D scanner is an example of a device that measures a degree of deterioration of each part that the anomaly prediction apparatus 100 includes. The device that measures the degree of deterioration of each part may be a sensor that each part includes.

The anomalous location prediction unit 110 calculates an arrangement of each part that a target device includes using data indicating a target deteriorated part, and simulates target behavior that is behavior of the target device based on the arrangement calculated. At this time, the anomalous location prediction unit 110 uses, as a specific example, a 3-D simulator. Here, a target part that the target device includes is regarded as deteriorated at a subject point in time and the target part at the subject point in time as the target deteriorated part.

The anomalous location prediction unit 110 calculates an arrangement of each part that the target device includes using data indicating a target part that is not deteriorated, and simulates reference behavior that is behavior of the target device based on the arrangement calculated.

In a case where there is a dissimilarity between the target behavior and the reference behavior, the anomalous location prediction unit 110 estimates based on a property of the target device, whether or not an anomaly will occur in the target device by the target deteriorated part becoming more deteriorated and a distance between a driving portion corresponding to the target part and a different part reaching an anomalous distance. Here, the driving portion corresponding to the target part may be the target part itself, and may be a part that is driven being interconnected with the target part. The driving portion corresponding to the target part may be a part that is deteriorated and may be a part that is not deteriorated. The driving portion corresponding to the target part may consist of a plurality of parts.

In a case where the anomaly is estimated to occur in the target device by the target deteriorated part becoming more deteriorated and the distance between the driving portion corresponding to the target part and the different part reaching the anomalous distance, the anomalous location prediction unit 110 calculates a residual distance corresponding to a driving portion corresponding to the target deteriorated part and the different part. The residual distance is a difference between the driving portion corresponding to the target deteriorated part and the different part, and the anomalous distance, and a remaining distance until an anomaly occurs in the device, and a distance corresponding to a reserve until the anomaly occurs in the device.

Specifically, the anomalous location prediction unit 110 calculates an arrangement of each part that the device includes using data corresponding to each deteriorated part and simulates behavior of the device based on the arrangement calculated. The device is also called the target device, and as a specific example, a manufacturing device. The part, as a specific example, is a gear, a bearing, or a shaft. The deterioration of the part means that the part changed from an initial state, and as a specific example, is a change in a shape of the part or a change in a position of the part. The change in the shape of the part, as a specific example, is wear of the part or deformation of the part. The data corresponding to each deteriorated part, as a specific example, is 3-D CAD (Computer Aided Design) data indicating each deteriorated part. The 3-D CAD data indicating each part, as a specific example, is obtained by sensing each part or by 3-D scanning of each part.

The anomalous location prediction unit 110 calculates between a plurality of points in time, arrangement of each part that the device includes, simulates behavior of the device based on the arrangement calculated, extracts a dissimilarity in the behavior of the device arising from the deterioration of each part based on the behavior simulated, and estimates whether or not each dissimilarity extracted is related to the anomaly of the device. The anomalous location prediction unit 110 may extract the dissimilarity in the behavior of the device based only on the deterioration of each part, and may estimate whether or not each dissimilarity extracted based on design information on the device or on a function of the device is related to the anomaly of the device. Each of the design information on the device and the function of the device is a specific example of a property of the device. The anomalous location prediction unit 110 locates an anomalous location corresponding to each dissimilarity extracted, and extracts a dissimilarity in physical distances in the anomalous location located. At this time, the anomalous location prediction unit 110 identifies a part that is related to the dissimilarity in the physical distances in the anomalous location located. The anomalous location, as a specific example, is an area including a driving portion that causes an anomaly that is related to each dissimilarity extracted or the driving portion. The dissimilarity in the physical distances in the anomalous location located, as a specific example, is a dissimilarity between a physical distance between a driving portion and a different part in the anomalous location of a reference arrangement model, and a physical distance between a driving portion and a different part in the anomalous location of a target arrangement model. Here, the reference arrangement model is a model indicating an arrangement of each part in a case where each part is not deteriorated. The target arrangement model is a model indicating an arrangement of each part in a case where each part is deteriorated. The anomalous location prediction unit 110, as a specific example, extracts as the dissimilarity in the physical distances in the anomalous location located, a dissimilarity in a distance between parts in the location located, or a dissimilarity in a position of the driving portion in the anomalous location located. The anomaly in the device, as a specific example, means the device does not behave normally or the device detects an anomaly of the device itself.

The anomalous location prediction unit 110 measures a residual distance in the anomalous location corresponding to a dissimilarity of each behavior related to the anomaly of the device. At this time, the anomalous location prediction unit 110, as a specific example, measures the residual distance using a model indicating the device. The anomalous location prediction unit 110, as a specific example, measures a dissimilarity between a distance between parts at one point in time and the anomalous distance as the residual distance. Here, the anomalous distance is a distance between parts that correspond to an anomaly occurring in the device. In a case where the distance between the parts is the anomalous distance, as a specific example, the parts collide with each other at a time of the device being driven and the device will not behave normally. The anomalous location prediction unit 110 may measure a distance from a position of the driving portion corresponding to the target part at a point in time to a position corresponding to a position anomaly relating to the driving portion corresponding to the target part as a residual distance corresponding to the target part. At this time, the position anomaly relating to the driving portion corresponding to the target part occurs by a relative position of the driving portion corresponding to the target part with respect to the different part changing. The residual distance does not have to be a distance that is a shortest route connecting two points such as a distance of a route that the part passes with the deformation of the part and the like.

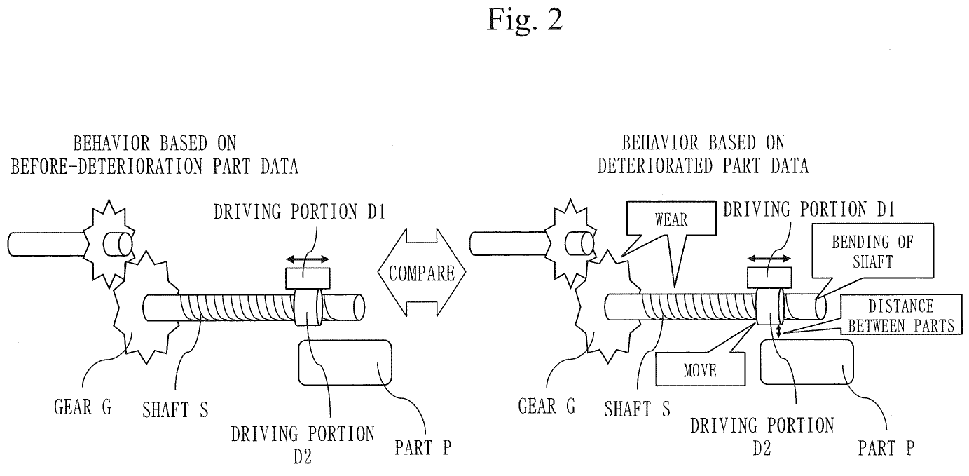

FIG. 2 is a diagram describing a process of the anomalous location prediction unit 110. As illustrated in FIG. 2, the anomalous location prediction unit 110 compares by a simulation, behavior of a device corresponding to data indicating each part that is not deteriorated with behavior of a device corresponding to each part that is deteriorated. In FIG. 2, behavior of a portion corresponding to an arrow changes and the change in the behavior is regarded as related to the anomaly of the device. As a specific example, in a case where gear G wears, behavior of driving portion D1 and driving portion D2 changes by a change in a way that force transfers.

In FIG. 2, deterioration of each part related to the anomalous location is illustrated by a bubble. Each part that is deteriorated is the target deteriorated part. In FIG. 2, a relative position of driving portion D1 with respect to a different part changes and a distance between driving portion D2 and part P changes by at least any one of the wear of gear G, wear of shaft S, bending of shaft S, and moving of driving portion D1. Here, driving portion D1 is the anomalous location. An area including a space that exists between driving portion D2 and part P is the anomalous location. Driving portion D1 is a driving portion corresponding to shaft S, a driving portion corresponding to gear G, and a driving portion corresponding to driving portion D2. Driving portion D2 is the driving portion corresponding to shaft S and the driving portion corresponding to gear G. Gear G and the like are different parts with respect to driving portion D1. Part P is a different part with respect to driving portion D2.

In a case where there is a dissimilarity between a relative position of the driving portion corresponding to the target deteriorated part with respect to the different part and a relative position of the driving portion corresponding to the target part with respect to the different part in a case where the target part is not deteriorated, and the anomaly is estimated to occur in the target device by the target deteriorated part becoming more deteriorated and the distance between the driving portion corresponding to the target part and the different part reaching the anomalous distance, the deterioration prediction unit 120 predicts a point in time when the anomaly will occur in the target device based on the residual distance. The deterioration prediction unit 120 may estimate an exchange period of the target part based on the point in time predicted when the anomaly will occur in the target device. The deterioration prediction unit 120 may predict the point in time when the anomaly will occur in the target device based on the residual distance and running time of the target device at the subject point in time.

As a specific example, the deterioration prediction unit 120 predicts an anomaly occurrence day using data indicating the residual distance at a plurality of points in time and information indicating the number of running days of the device. The anomaly occurrence day is a specific example of a point in time when an anomaly occurs in the target device. The anomaly occurrence day, as a specific example, is a day when a distance between parts on a deterioration curve reaches the anomalous distance. The deterioration curve is a model generated using data indicating deterioration of the target deteriorated part obtained at the subject point in time and data indicating deterioration of the target part obtained at a point in time before the subject point in time, and is equivalent to a model indicating a change in the distance between the driving portion corresponding to the target part and the different part in a time series. The deterioration prediction unit 120 may predict the point in time when the anomaly occurs in the target device based on the model. The deterioration curve, as a specific example, is a curve derived based on the running time of the device and a deterioration model of the part, and is a curve indicating a temporal transition of the residual distance. The deterioration model is a model indicating deterioration of each part in a time series. The deterioration model may be a typical model.

The deterioration prediction unit 120 may predict the anomaly occurrence day using AI (Artificial Intelligence). At this time, an inference model that the deterioration prediction unit 120 uses, as a specific example, is a model learned using data obtained from a device of a same kind as a device that is a target or a part of a same kind as a part that is the target. As a specific example, input for AI is data indicating the residual distance, and output of AI is the deterioration curve.

The deterioration prediction unit 120 calculates an exchange period of a part that is deteriorated based on the anomaly occurrence day predicted, and presents the exchange period calculated to a user. At this time, the deterioration prediction unit 120 may calculate the exchange period taking a margin of error that the anomaly occurrence day predicted has into consideration.

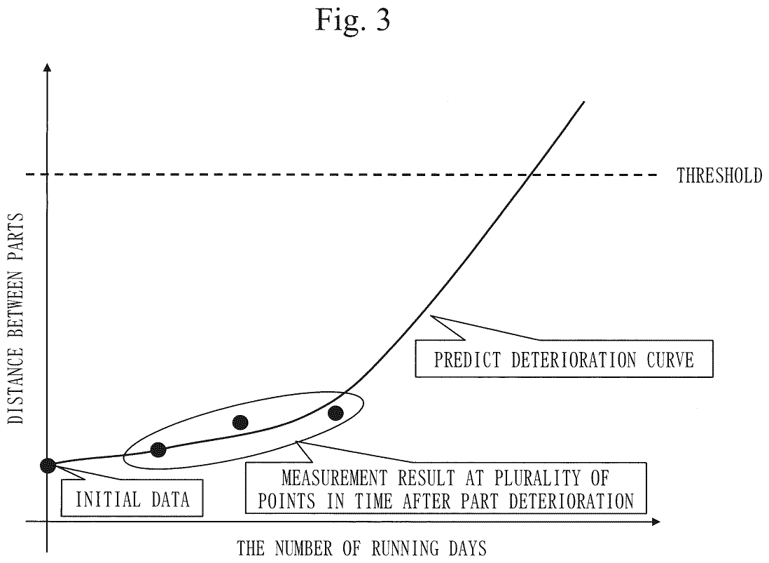

FIG. 3 is a diagram describing a process of the deterioration prediction unit 120.

The deterioration prediction unit 120 predicts the deterioration curve based on a result of measuring the degree of deterioration of each part at the plurality of points in time. Here, the deterioration curve illustrated in FIG. 3 is a curve representing a relationship between the number of running days of the device and the distance between the parts. The distance between the parts corresponds to the residual distance. Initial data is data corresponding to each part that is not deteriorated. There is a case where the distance between the parts is reduced with elapsed time.

Next, the deterioration prediction unit 120 calculates a day that the distance between the parts reaches a threshold by taking the number of running days of the device into consideration. Here, the threshold corresponds to the anomalous distance.

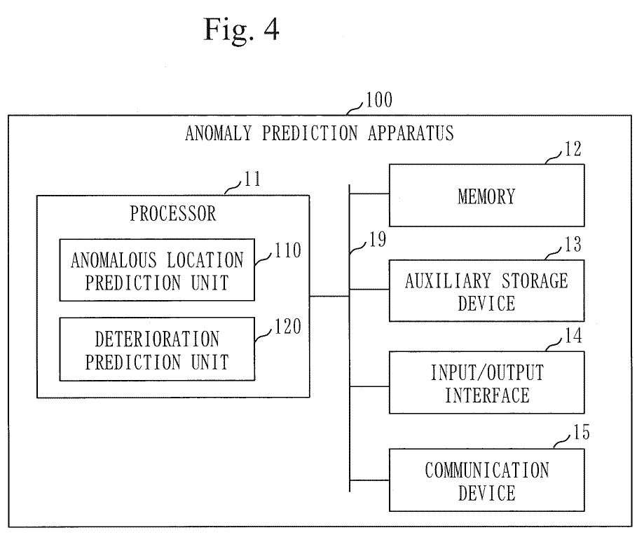

FIG. 4 illustrates an example of a hardware configuration of the anomaly prediction apparatus 100 according to the present embodiment. The anomaly prediction apparatus 100 consists of a computer. The anomaly prediction apparatus 100 may consist of a plurality of computers.

The anomaly prediction apparatus 100, as illustrated in the present diagram, is a computer that includes hardware such as a processor 11, a memory 12, an auxiliary storage device 13, an input/output interface 14, a communication device 15, and the like. These pieces of hardware are suitably connected through a signal line 19.

The processor 11 is an IC (Integrated Circuit) that performs a calculation process, and controls hardware that the computer includes. The processor 11, as a specific example, is a CPU (Central Processing Unit), a DSP (Digital Signal Processor), or a GPU (Graphics Processing Unit).

The anomaly prediction apparatus 100 may include a plurality of processors that replace the processor 11. The plurality of processors share roles of the processor 11.

The memory 12 is typically a volatile storage device, and as a specific example, is a RAM (Random Access Memory). The memory 12 is also called a main storage device or a main memory. Data stored in the memory 12 is saved in the auxiliary storage device 13 as necessary.

The auxiliary storage device 13 is typically a non-volatile storage device, and as a specific example, is a ROM (Read Only Memory), an HDD (Hard Disk Drive), or a flash memory. Data stored in the auxiliary storage device 13 is loaded into the memory 12 as necessary.

The memory 12 and the auxiliary storage device 13 may be configured integrally.

The input/output interface 14 is a port to which an input device and an output device are connected. The input/output interface 14, as a specific example, is a USB (Universal Serial Bus) terminal. Input devices, as specific examples, are a keyboard and a mouse. The output device, as a specific example, is a display.

The communication device 15 is a receiver and a transmitter. The communication device 15, as a specific example, is a communication chip or an NIC (Network Interface Card).

Each unit of the anomaly prediction apparatus 100 may suitably use the input/output interface 14 and the communication device 15 when communicating with a different device and the like.

The auxiliary storage device 13 has stored an anomaly prediction program. The anomaly prediction program is a program that causes a computer to enable functions of each unit that the anomaly prediction apparatus 100 includes. The anomaly prediction program is loaded into the memory 12, and executed by the processor 11. The functions of each unit that the anomaly prediction apparatus 100 includes are enabled by software.

Data used when executing the anomaly prediction program, data obtained by executing the anomaly prediction program and the like are suitably stored in a storage device. Each unit of the anomaly prediction apparatus 100 suitably utilizes the storage device. The storage device, as a specific example, consists of at least one of the memory 12, the auxiliary storage device 13, a register in the processor 11, and a cache memory in the processor 11. There is a case where a term “data” and a term “information” have an equal meaning. The storage device may be a device that is independent of the computer.

Functions of the memory 12 and the auxiliary storage device 13 may be enabled by a different storage device.

The anomaly prediction program may be recorded in a computer-readable non-volatile recording medium. The non-volatile recording medium, as a specific example, is an optical disc or a flash memory. The anomaly prediction program may be provided as a program product.

### ***Description of Operation***

An operation procedure of the anomaly prediction apparatus 100 is equivalent to an anomaly prediction method. A program that enables operation of the anomaly prediction apparatus 100 is equivalent to the anomaly prediction program.

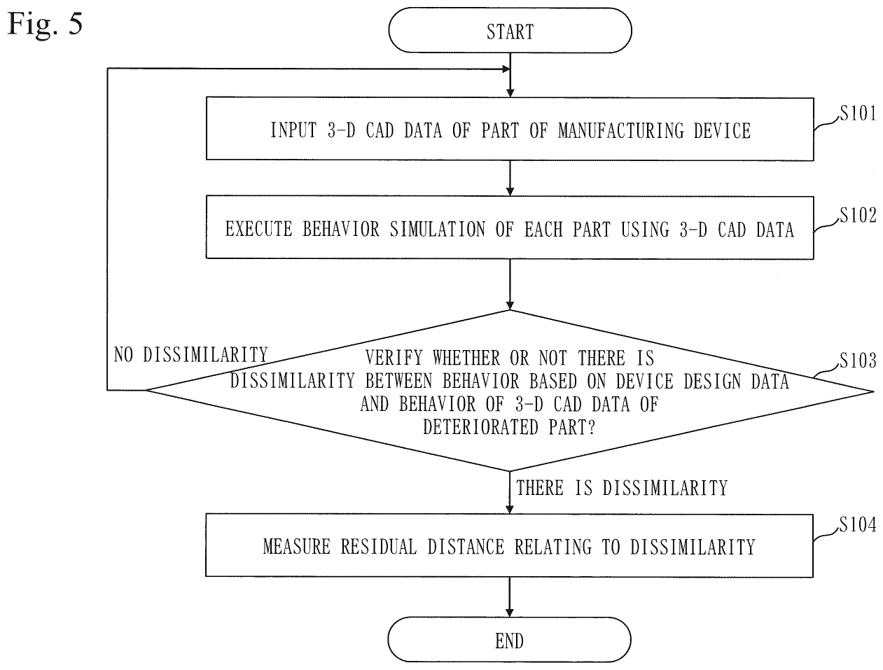

FIG. 5 is a flowchart illustrating an example of operation of the anomalous location prediction unit 110. The operation of the anomalous location prediction unit 110 will be described using FIG. 5.

### (Step S101)

The anomalous location prediction unit 110 accepts the 3-D CAD data indicating each part of the device as input. Here, each part that the 3-D CAD data indicates is regarded as deteriorated.

### (Step S102)

The anomalous location prediction unit 110 calculates the arrangement of each part that the device includes using the 3-D CAD data accepted, and simulates the behavior of the device based on the arrangement calculated. At this time, the anomalous location prediction unit 110 may use 3-D CAD data that is prepared beforehand indicating each part for each part that the 3-D CAD data accepted does not indicate.

### (Step S103)

The anomalous location prediction unit 110 verifies whether or not there is a dissimilarity between behavior of the device in simulation based on the arrangement of each part that the device includes calculated using device design data and the behavior of the device simulated in step S102. Here, the device design data is 3-D CAD data indicating each part that is not deteriorated.

In a case where there is a dissimilarity in the behavior of the device, the anomalous location prediction unit 110 proceeds to step S104. In other cases, the anomalous location prediction unit 110 proceeds to step S101.

### (Step S104)

In a case where the dissimilarity in the behavior verified in step S103 is related to a failure in the device, the anomalous location prediction unit 110 locates the anomalous location corresponding to the dissimilarity in the behavior, and measures a residual distance in each anomalous location located.

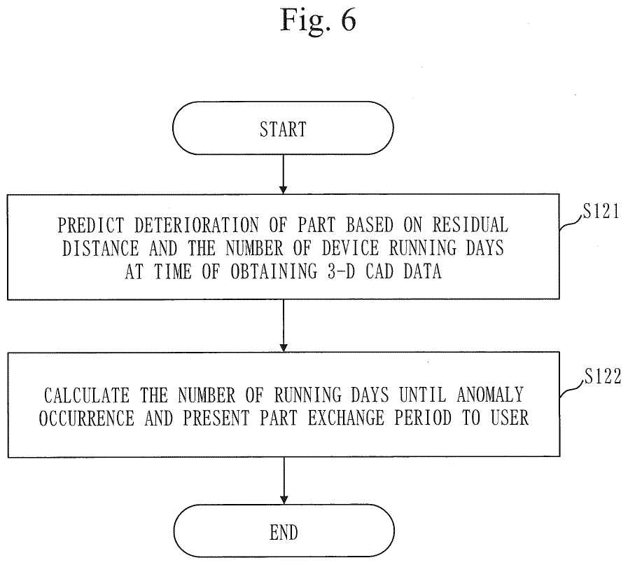

FIG. 6 is a flowchart illustrating an example of operation of the deterioration prediction unit 120. The operation of the deterioration prediction unit 120 will be described using FIG. 6.

### (Step S121)

The deterioration prediction unit 120 predicts deterioration of a part corresponding to each residual distance based on each residual distance that the anomalous location prediction unit 110 measured and the number of running days of the device at a point in time 3-D data corresponding to each residual distance was obtained.

### (Step S122)

The deterioration prediction unit 120 calculates the number of running days of the device until the anomaly occurs in the device based on a result predicted in step S121, calculates an exchange period of the part based on the number of running days calculated, and presents the exchange period of the part calculated to a user.

### ***Description of Effect of Embodiment 1.***

As described above, according to the present embodiment, with regard to a failure relating to the physical distance due to the plurality of parts of the device deteriorating, an exchange part can be identified and the exchange period of the part can be derived without obtaining data relating to an anomalous state of the device beforehand.

### ***Other Configurations***

### <Variation 1>

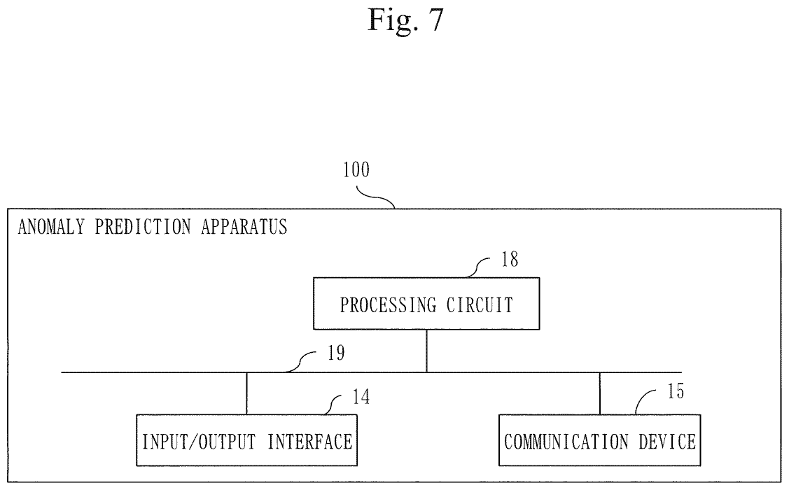

FIG. 7 illustrates an example of a hardware configuration of an anomaly prediction apparatus 100 according to the present variation.

The anomaly prediction apparatus 100 includes a processing circuit 18 instead of the processor 11, the processor 11 and the memory 12, the processor 11 and the auxiliary storage device 13, or the processor 11, the memory 12, and the auxiliary storage device 13.

The processing circuit 18 is hardware that enables at least a part of each unit that the anomaly prediction apparatus 100 includes.

The processing circuit 18 may be dedicated hardware and may be a processor that executes a program stored in the memory 12.

In a case where the processing circuit 18 is dedicated hardware, the processing circuit 18, as a specific example, is a single circuit, a composite circuit, a programmed processor, a parallel programmed processor, an ASIC (Application Specific Integrated Circuit), an FPGA (Field Programmable Gate Array), or a combination of these.

The anomaly prediction apparatus 100 may include a plurality of processing circuits that replace the processing circuit 18. The plurality of processing circuits share roles of the processing circuit 18.

In the anomaly prediction apparatus 100, some of functions may be enabled by dedicated hardware and the rest of the functions may be enabled by software or firmware.

The processing circuit 18, as a specific example, is enabled by hardware, software, firmware, or a combination of these.

The processor 11, the memory 12, the auxiliary storage device 13, and the processing circuit 18 are generically called “processing circuitry”. That is, functions of each functional element of the anomaly prediction apparatus 100 are enabled by the processing circuitry.

As for the anomaly prediction apparatus 100 according to other embodiments, the anomaly prediction apparatus 100 may be in a same configuration as the configuration in the present variation.

### Embodiment 2

Points different from the embodiment mentioned above will mainly be described below by referring to the drawings.

### ***Description of Configuration***

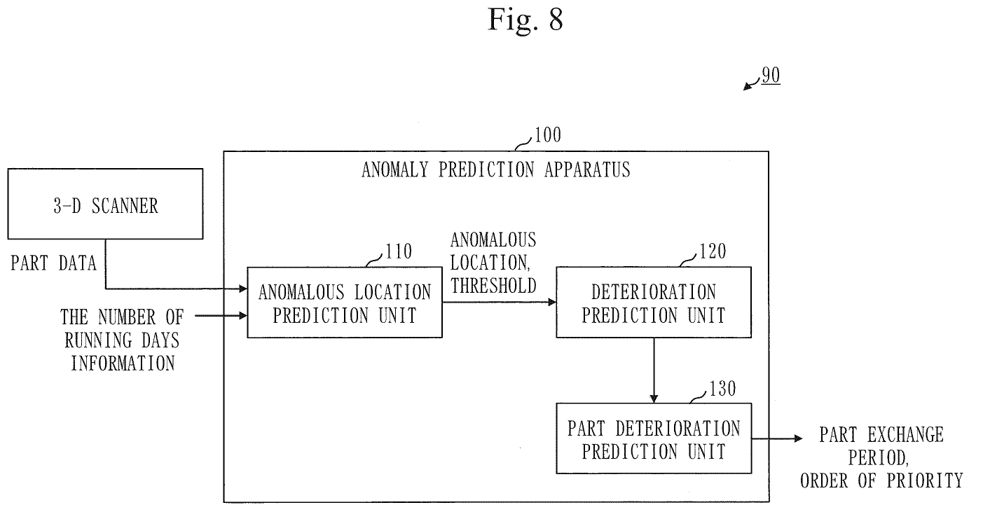

FIG. 8 illustrates an example of a configuration of an anomaly prediction apparatus 100 according to the present embodiment. The anomaly prediction apparatus 100 further includes a part deterioration prediction unit 130.

The part deterioration prediction unit 130 calculates a degree to which a residual distance corresponding to the target part and the different part will be improved by exchanging the target part that is deteriorated for the target part that is not deteriorated as a degree of effect corresponding to the target part. As a specific example, the part deterioration prediction unit 130 estimates a deterioration amount of the target part at the point in time the anomaly is predicted by the deterioration prediction unit 120 to occur in the target device, calculates each of a first residual distance and a second residual distance, and calculates the degree of effect corresponding to the target part based on the first residual distance and the second residual distance calculated. Here, the first residual distance is a residual distance corresponding to the driving portion corresponding to the target part, and the different part, of a case where a deterioration amount of the target part is regarded as the deterioration amount estimated. The second residual distance is a residual distance corresponding to the driving portion corresponding to the target part, and the different part, of a case where the target deteriorated part is exchanged for the target part that is not deteriorated. In a case where a plurality of parts that are deteriorated that affect the residual distance exist, the part deterioration prediction unit 130 calculates a degree of effect corresponding to each of the plurality of parts that are deteriorated, and calculates an order of priority relating to a part exchange for each of the plurality of parts that are deteriorated based on the degree of effect calculated.

In the following, a specific example of a process of the part deterioration prediction unit 130 will be described.

First, the part deterioration prediction unit 130 predicts, based on the data corresponding to each part that is deteriorated, a deterioration amount of each part on the anomaly occurrence day that the deterioration prediction unit 120 predicted.

Next, the part deterioration prediction unit 130 generates data corresponding to each part on the anomaly occurrence day based on the deterioration amount of each part predicted.

Next, the part deterioration prediction unit 130 calculates an arrangement of each part that a device in each combination of the part that is deteriorated and the part that is not deteriorated includes using the data generated and the data indicating each part that is not deteriorated. That is, the part deterioration prediction unit 130 calculates an arrangement of each part that a device in a case where some of the parts are exchanged on the anomaly occurrence day includes.

Next, the part deterioration prediction unit 130 predicts a degree of effect corresponding to each part with respect to an anomaly corresponding to the anomaly occurrence day based on the arrangement of each part calculated, and estimates the order of priority relating to the exchange of each part and a period of exchange of each part based on the degree of effect predicted. A degree of effect corresponding to a certain part is a degree to which the arrangement of each part that the device includes will be restored by exchanging the certain part. The degree of effect corresponding to the certain part, as a specific example, is a residual distance that is increased or decreased by exchanging the certain part with a new part.

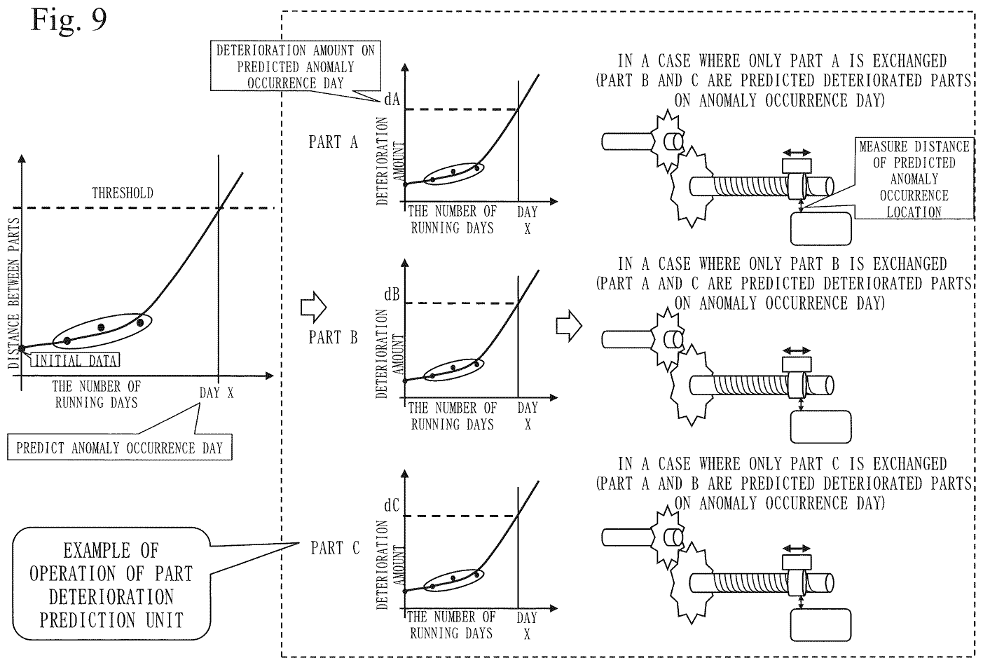

FIG. 9 is a diagram describing a process of the part deterioration prediction unit 130.

First, the part deterioration prediction unit 130 calculates a deterioration amount of each part on day X that is the anomaly occurrence day that the deterioration prediction unit 120 predicted. In FIG. 9, a deterioration amount of part A on day X is represented as dA as a specific example.

Next, the part deterioration prediction unit 130 calculates an arrangement of each part on day X regarding the target part as having been exchanged on day X based on the deterioration amount calculated, and calculates a residual distance on day X based on a result calculated. At this time, the part deterioration prediction unit 130 typically calculates the arrangement of each part on day X with one part as the target part.

Next, the part deterioration prediction unit 130 calculates based on the arrangement calculated, the degree of effect corresponding to each part by comparing residual distances in a case where each part is exchanged on day X.

### ***Description of Operation***

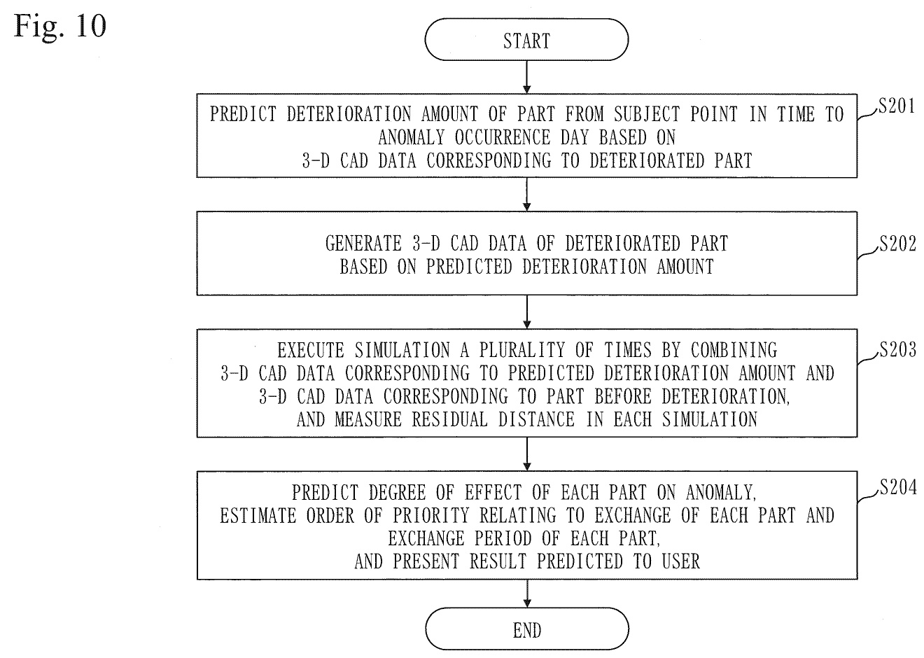

FIG. 10 is a flowchart illustrating an example of operation of the part deterioration prediction unit 130. The operation of the part deterioration prediction unit 130 will be described using FIG. 10.

### (Step S201)

The part deterioration prediction unit 130 predicts a deterioration amount of each part from the subject point in time to the anomaly occurrence day that the deterioration prediction unit 120 predicted using the 3-D CAD data indicating each part that is deteriorated at the subject point in time.

### (Step S202)

The part deterioration prediction unit 130 generates 3-D CAD data indicating each part on the anomaly occurrence day based on the deterioration amount of each part predicted.

### (Step S203)

The part deterioration prediction unit 130 calculates the arrangement of each part that the device in each combination of the part that is deteriorated and the part that is not deteriorated includes using the 3-D CAD data generated in step S202 and the 3-D CAD data indicating each part that is not deteriorated, and measures a residual distance in each combination.

### (Step S204)

The part deterioration prediction unit 130 predicts a degree of effect of each part on an anomaly corresponding to the residual distance measured in step S203, estimates a priority order relating to the exchange of each part and the exchange period of each part, and presents a result predicted to a user.

### ***Description of Effect of Embodiment 2.***

As described above, according to the present embodiment, since the exchange period that is appropriate for each part can be predicted, longer life of the part can be sought while avoiding failure of the device.

### Other Embodiments

A free combination of each embodiment mentioned above, or a variation of any element of each embodiment, or omitting of any element in each embodiment is possible.

The embodiments are not to be limited to the embodiments indicated in Embodiment 1 to 2, and various changes are possible to be made as necessary. Procedures described using the flowcharts and the like may suitably be changed.

### REFERENCE SIGNS LIST

11: processor, 12: memory; 13: auxiliary storage device; 14: input/output interface; 15: communication device; 18: processing circuit; 19: signal line; 90: anomaly prediction system; 100: anomaly prediction apparatus; 110: anomalous location prediction unit; 120: deterioration prediction unit; 130: part deterioration prediction unit.

1. An anomaly prediction apparatus comprising:
processing circuitry to:
regarding a target part that a target device includes as deteriorated at a subject point in time and the target part at the subject point in time as a target deteriorated part,
predict a point in time an anomaly will occur in the target device, in a case where there is a dissimilarity between a relative position of a driving portion corresponding to the target deteriorated part with respect to a different part and a relative position of a driving portion corresponding to the target part of a case where the target part is not deteriorated with respect to the different part, and the anomaly is estimated to occur in the target device by the target deteriorated part becoming more deteriorated and a distance between the driving portion corresponding to the target part and the different part reaching an anomalous distance, based on a residual distance that is a difference between the distance between the driving portion corresponding to the target deteriorated part and the different part, and the anomalous distance.

2. The anomaly prediction apparatus according to claim 1, wherein
the processing circuitry
predicts the point in time the anomaly will occur in the target device based on a model indicating a change in a distance between a driving portion corresponding to the target part generated using data indicating deterioration of the target deteriorated part obtained at the subject point in time and data indicating deterioration of the target part obtained at a point in time before the subject point in time, and the different part in a time series.

3. The anomaly prediction apparatus according to claim 1, wherein
the processing circuitry
estimates an exchange period of the target part based on the point in time the anomaly will occur in the target device predicted.

4. The anomaly prediction apparatus according to claim 1, wherein
the processing circuitry
calculates an arrangement of each part that the target device includes using data indicating the target deteriorated part, and simulates target behavior that is behavior of the target device based on the arrangement calculated,
calculates the arrangement of each part that the target device includes using data indicating the target part that is not deteriorated, and simulates reference behavior that is behavior of the target device based on the arrangement calculated,
in a case where there is a dissimilarity between the target behavior and the reference behavior, estimates whether or not the anomaly will occur in the target device by the target deteriorated part becoming more deteriorated and the distance between the driving portion corresponding to the target part and the different part reaching the anomalous distance based on a property of the target device, and
in a case where the anomaly is estimated to occur in the target device by the target deteriorated part becoming more deteriorated and the distance between the driving portion corresponding to the target part and the different part reaching the anomalous distance, calculates a residual distance corresponding to the driving portion corresponding to the target deteriorated part and the different part.

5. The anomaly prediction apparatus according to claim 1, wherein
the processing circuitry
calculates a degree to which a residual distance corresponding to the driving portion corresponding to the target part and the different part will be improved by exchanging the target part that is deteriorated for the target part that is not deteriorated as a degree of effect corresponding to the target part.

6. The anomaly prediction apparatus according to claim 5, wherein
the processing circuitry
predicts the point in time the anomaly will occur in the target device based on the residual distance and running time of the target device at the subject point in time, and
estimates a deterioration amount of the target part at the point in time the anomaly is predicted to occur in the target device, calculates as a first residual distance, a residual distance corresponding to the driving portion corresponding to the target part, and the different part, of a case where a deterioration amount of the target part is regarded as the deterioration amount estimated, calculates as a second residual distance, a residual distance corresponding to the driving portion corresponding to the target part, and the different part, of a case where the target deteriorated part is exchanged for the target part that is not deteriorated, and calculates the degree of effect corresponding to the target part based on the first residual distance and the second residual distance.

7. The anomaly prediction apparatus according to claim 5, wherein
the processing circuitry
in a case where a plurality of parts that are deteriorated that affect the residual distance exist, calculates a degree of effect corresponding to each of the plurality of parts that are deteriorated, and calculates an order of priority relating to a part exchange for each of the plurality of parts that are deteriorated based on the degree of effect calculated.

8. An anomaly prediction system comprising:
the anomaly prediction apparatus according to claim 1; and
a device to measure a degree of deterioration of the target part.

9. An anomaly prediction method comprising:
regarding a target part that a target device includes as deteriorated at a subject point in time and the target part at the subject point in time as a target deteriorated part,
to predict a point in time an anomaly will occur in the target device, in a case where there is a dissimilarity between a relative position of a driving portion corresponding to the target deteriorated part with respect to a different part and a relative position of a driving portion corresponding to the target part of a case where the target part is not deteriorated with respect to the different part, and the anomaly is estimated to occur in the target device by the target deteriorated part becoming more deteriorated and a distance between the driving portion corresponding to the target part and the different part reaching an anomalous distance, based on a residual distance that is a difference between the distance between the driving portion corresponding to the target deteriorated part and the different part, and the anomalous distance, by a computer.

10. A non-transitory computer readable medium storing an anomaly prediction program that causes an anomaly prediction apparatus that is a computer to execute:
a deterioration prediction process, regarding a target part that a target device includes as deteriorated at a subject point in time and the target part at the subject point in time as a target deteriorated part,
to predict a point in time an anomaly will occur in the target device, in a case where there is a dissimilarity between a relative position of a driving portion corresponding to the target deteriorated part with respect to a different part and a relative position of a driving portion corresponding to the target part of a case where the target part is not deteriorated with respect to the different part, and the anomaly is estimated to occur in the target device by the target deteriorated part becoming more deteriorated and a distance between the driving portion corresponding to the target part and the different part reaching an anomalous distance, based on a residual distance that is a difference between the distance between the driving portion corresponding to the target deteriorated part and the different part, and the anomalous distance.
